(19) United States
(12) Patent Application Publication
(10) Pub. No.: US 2015/0332394 A1
(43) Pub. Date: Nov. 19, 2015

(54) METHOD AND SYSTEM FOR PRODUCT DEMAND/SUPPLY CONNECTION NETWORK SERVICE BASED ON TARIFF-HARMONIZED COMMODITY DESCRIPTION CODES

(71) Applicants: Jong Seok KANG, Goyang-si (KR); Hyuck Jai LEE, Seoul (KR); Bang Rae LEE, Seoul (KR); Se Jung AHN, Seoul (KR); Hyun Sang JUNG, Busan (KR); Yeong Ho MOON, Seoul (KR)

(72) Inventors: Jong Seok KANG, Goyang-si (KR); Hyuck Jai LEE, Seoul (KR); Bang Rae LEE, Seoul (KR); Se Jung AHN, Seoul (KR); Hyun Sang JUNG, Busan (KR); Yeong Ho MOON, Seoul (KR)

(73) Assignee: KOREA INSTITUTE OF SCIENCE AND TECHNOLOGY INFORMATION, Daejeon (KR)

(21) Appl. No.: 14/396,343

(22) PCT Filed: May 11, 2012
(86) PCT No.: PCT/KR2012/003694

§ 371 Date: Oct. 22, 2014

(30) Foreign Application Priority Data
Apr. 25, 2012 (KR) 10-2012-0043350

(51) Int. Cl. G06Q 40/04

(52) U.S. Cl. CPC G06Q 40/04

(57) ABSTRACT

A system for a product demand/supply connection network service based on tariff-harmonized commodity description codes, and a method for the same are provided. The method comprises: receiving a list of commodities based on tariff-harmonized commodity description codes from a trade information providing device via a communication network; classifying the received list of commodities into datasets on the basis of HS codes; generating the commodity list classified into the datasets as a hierarchical structure of a forward-oriented or reverse-oriented demand/supply connection network; and providing trade volume information of import and export related products, providing chemical abstract service (CAS) numbers, technical patent numbers, and product restriction information, or providing a list of commodities for each trade partner and each trade region on the basis of the hierarchical structure of the forward-oriented or reverse-oriented demand/supply connection network.

### TECHNICAL FIELD

The present invention relates to a product demand/supply connection network service for sorting trade products based on Harmonized System (HS) codes obtained by generally sorting foreign trade transaction products in accordance with the Harmonized Commodity Description and Coding System and providing the sorted trade products in the form of the hierarchical structure of a forward-oriented demand/supply connection network or in the form of the hierarchical structure of a backward-oriented demand/supply connection network.

### BACKGROUND ART

Recently, as the use of the Internet is gradually expanded and communities within a space based on the Internet are formed, one of things that become more important is a technology for efficiently managing and integrating pieces of information and using the pieces of information.

Nevertheless, the mutual exchange of pieces of information through the Internet has not been integrated and managed, but is managed by the efforts of respective sites, and only users who are aware of the sites or who have rights capable of accessing the sites are able to obtain information. Furthermore, information that may be obtained like so is not sufficiently obtained to the extent that the information is satisfactory due to the physical limit of a site user.

That is, a current knowledge sharing system is problematic in that the system is constructed using a conventional Internet method, that is, a web bulletin board, search is performed by people having rights capable of accessing the bulletin board only within a corresponding site, and retrieved contents are specifically limited depending on the task property of a corresponding site provider.

Knowledge provided through the Internet, however, is explosively increased along with the development of networks. Accordingly, in order to remove inefficiency and a high cost in efforts and costs required for a search process when knowledge required for a user is to be searched for, there is a strong need for a knowledge database that may be shared. In order to provide excellent content in such an environment, considerable expenses and human power must be invested systematically and designedly. There has been a need for an efficient system capable of constructing a database using content based on users' spontaneous participation.

Meanwhile, a database for implementing a product demand and supply connection network can be constructed by incorporating the use of an individual constructed product and the combinational and hierarchical characteristics of elements into the database. In a current IT level, attempts have been made at artificial intelligence and semantic technologies, but an example in which the database has been constructed is not present.

### DISCLOSURE

### Technical Problem

An object of the present invention for solving the aforementioned disadvantages is to provide a product demand/supply connection network service method and system based on tariff-harmonized commodity description codes, wherein trade products are sorted based on HS codes, that is, item classification codes obtained by generally sorting foreign trade transaction products in accordance with the Harmonized Commodity Description and Coding System, relationships between the trade products are connected to the raw materials, intermediate body, and completed body of a product, and the trade products are provided in the form of the hierarchical structure of a forward-oriented demand/supply connection network so that it is revealed that what completed body has been formed by the raw materials of the product or in the form of the hierarchical structure of a backward-oriented demand/supply connection network so that it is revealed that the completed body has been formed through which process.

### Technical Solution

In accordance with an aspect of the present invention for achieving the object, there is provided a product demand/supply connection network service method based on tariff-harmonized commodity description codes in a technology market-associated analysis apparatus including microprocessor that controls a product demand/supply connection network service, including the steps of (a) fetching, by the microprocessor, items based on the tariff-harmonized commodity description codes from a trade information providing apparatus over a communication network; (b) classifying, by the microprocessor, the fetched items into data sets based on Harmonized System (HS) codes; (c) generating, by the microprocessor, the items classified into the data sets in the form of the hierarchical structure of a forward-oriented or backward-oriented demand/supply connection network; and (d) providing, by the microprocessor, information about an amount of trade of export- and import-related products, information about Chemistry Abstract Service (CAS) registry numbers, technical patent numbers, and product regulations, or trade target countries and region-based items based on the hierarchical structure of the forward-oriented or backward-oriented demand/supply connection network.

Furthermore, the step (b) may include classifying, by the microprocessor, the items into the data sets according to regions, uses, and designated items.

Furthermore, the step (c) may include generating, by the microprocessor, the items in the form of the hierarchical structure in which the forward-oriented demand/supply connection network or the backward-oriented demand/supply connection network is able to be selected.

Furthermore, the hierarchical structure of the forward-oriented demand/supply connection network may be a structure in which the items of the product are connected to raw materials, intermediate/partial bodies of the product, and the completed body, thus revealing that what completed body has been formed by the raw materials of the product, and the hierarchical structure of the backward-oriented demand/supply connection network may be a structure that reveals that the completed body has been formed through which process.

Furthermore, the step (d) may include providing, by the microprocessor, the information about the amount of trade of the export- and import-related products, the information about the Chemistry Abstract Service (CAS) registry numbers, technical patent numbers, and product regulations, or the trade target countries and the region-based items according to a combination of queries or a combination of words.

Meanwhile, in accordance with another aspect of the present invention for achieving the object, there is provided a product demand/supply connection network service system based on tariff-harmonized commodity description codes, including an information collection unit collecting trade information, including the tariff-harmonized commodity description codes (Harmonized System (HS) codes), from a trade information providing apparatus over a communication network; a data classification unit fetching items based on the tariff-harmonized commodity description codes from the trade information and classifying the fetched items into data sets based on the HS codes; a connection network configuration generation unit generating the items, classified into the data sets, in the form of the hierarchical structure of a forward-oriented or backward-oriented demand/supply connection network; and a service providing unit providing information about an amount of trade of export- and import-related products, providing Chemistry Abstract Service (CAS) registry numbers, technical patent numbers, and product regulations, or providing trade target countries and region-based items based on the hierarchical structure of the forward-oriented or backward-oriented demand/supply connection network.

Furthermore, the information collection unit may collect patent information from a patent information providing apparatus, the CAS numbers from a chemistry information providing apparatus, and manufacturing company information from a manufacturing company information providing apparatus with respect to information required for the product demand/supply connection network.

Furthermore, the data classification unit may classify the items into the data sets according to regions, uses, and designated items.

Furthermore, the connection network configuration generation unit may generate the items in the form of the hierarchical structure in which the forward-oriented demand/supply connection network or the backward-oriented demand/supply connection network is able to be selected.

Furthermore, the hierarchical structure of the forward-oriented demand/supply connection network may be a structure in which the items of the product are connected to raw materials, intermediate/partial bodies of the product, and the completed body, thus revealing that what completed body has been formed by the raw materials of the product, and the hierarchical structure of the backward-oriented demand/supply connection network may be a structure that reveals that the completed body has been formed through which process.

Furthermore, the service providing unit may provide the information about the amount of trade of the export- and import-related products, the information about the Chemistry Abstract Service (CAS) registry numbers, technical patent numbers, and product regulations, or the trade target countries and the region-based items according to a combination of queries or a combination of words.

### Advantageous Effects

In accordance with the present invention, patent information, trade information, chemistry information, and manufacturing company information can be checked at a time over a product demand and supply connection network for a product to be searched for.

Furthermore, a product demand/supply connection network based on tariff-harmonized commodity description codes can be provided to users, and a user can check a product to be searched for in the form of the hierarchical structure of a forward-oriented or backward-oriented demand/supply connection network.

Furthermore, a current information situation and related industry technology information for the raw materials, intermediate body, and partial body of a product to be searched for and the completed body of the product can be quickly checked, and technical development and a market tendency can be easily checked.

### DESCRIPTION OF DRAWINGS

FIG. 1 is a block diagram illustrating an overall configuration of a product demand/supply connection network service system based on tariff-harmonized commodity description codes in accordance with an embodiment of the present invention.

FIG. 2 is a block diagram schematically illustrating the functions of a technology market-associated analysis apparatus in accordance with an embodiment of the present invention.

FIG. 3 illustrates a flowchart for illustrating a product demand/supply connection network service method based on tariff-harmonized commodity description codes in the technology market-associated analysis apparatus in accordance AO with an embodiment of the present invention.

FIG. 4 is a diagram illustrating an example in which pieces of trade-related information are classified into a plurality of data sets based on HS codes in accordance with an embodiment of the present invention.

FIG. 5 is a diagram illustrating the hierarchical structure of a forward-oriented demand/supply connection network in accordance with an embodiment of the present invention.

FIG. 6 is a diagram illustrating the hierarchical structure of a backward-oriented demand/supply connection network in accordance with an embodiment of the present invention.

FIG. 7 is a diagram illustrating an example of a database in which pieces of information used for a product demand/supply connection network service are matched with HS codes in accordance with an embodiment of the present invention.

### BEST MODE

The details of the object and technical construction of the present invention and acting effects thereof will become more clearly understood from the following detailed description based on the drawings accompanied by the specification of the present invention. Hereinafter, embodiments of the present invention are described in detail with reference to the accompanying drawings.

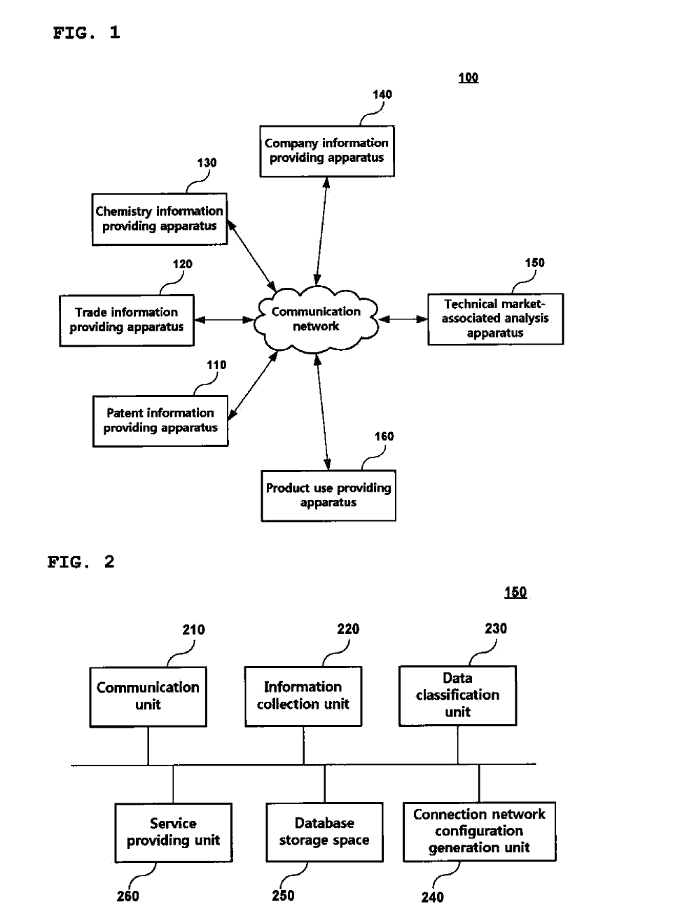

FIG. 1 is a block diagram illustrating an overall configuration of a product demand/supply connection network service system based on tariff-harmonized commodity description codes in accordance with an embodiment of the present invention.

Referring to FIG. 1, the product demand/supply connection network service system 100 based on tariff-harmonized commodity description codes in accordance with an embodiment of the present invention includes a patent information providing apparatus 110, a trade information providing apparatus 120, a chemistry information providing apparatus 130, a company information providing apparatus 140, a technology market-associated analysis apparatus 150, a product use providing apparatus 160, and so on.

In this case, the technology market-associated analysis apparatus 150 is an apparatus for constructing a database for a product demand/supply connection network in accordance with an embodiment of the present invention and providing analysis information associated with technology markets based on the constructed database. To this end, the technology market-associated analysis apparatus 150 communicate with the patent information providing apparatus 110, the trade information providing apparatus 120, the chemistry information providing apparatus 130, and the company information providing apparatus 140 over a communication network.

In this case, the technology market-associated analysis apparatus 150 fetches items based on tariff-harmonized commodity description codes from the trade information providing apparatus 120 over the communication network, classifies the fetched items into data sets based on Harmonized System (HS) codes, generates the items classified into the data sets in the form of the hierarchical structure of a forward-oriented or backward-oriented demand/supply connection network, and provides information about the amount of trade of export- and import-related products based on the hierarchical structure of the forward-oriented or backward-oriented demand/supply connection network, provides information about Chemical Abstract Service (CAS) registry numbers, technical patent numbers, and product regulations, or provides trade target countries and region-based items. In such a case, the technology market-associated analysis apparatus 150 provides the information about the amount of trade of the export- and import-related products, provides the information about the CAS numbers, technical patent numbers, and product regulations, or provides the trade target countries and the region-based items according to a combination of queries or a combination of words.

Furthermore, the patent information providing apparatus 110 is an apparatus for providing information related to patent and may be a server computer for providing patent information by the Patent Office or a civilian organization in each country. In the case of the Republic of Korea, the patent information providing apparatus 110 may be KIPRIS or WIPS, for example.

Furthermore, the trade information providing apparatus 120 may be a server computer for providing information related to trade by a trade institution, trade research worker, trade organization, or trade association in each country, for example. In particular, the trade information providing apparatus 120 provides Harmonized System (HS) codes that are included in information related to trade and that are about trade products.

Furthermore, the chemistry information providing apparatus 130 may be a server computer for providing information related to chemistry by a chemical institution, chemical organization, chemistry research worker, or chemical association in each country, for example. In particular, the chemistry information providing apparatus 130 provides Chemistry Abstract Service (CAS) registry numbers that are included in information related to chemistry and that are about corresponding products.

Furthermore, the company information providing apparatus 140 may be a server computer for providing information related to a manufacturing company, for example, a company name, foundation date, the number of employees, yearly sales, manufacturing items, and export items. An example of the company information providing apparatus 140 may be the server computer of a stock exchange that provides information about companies on list or KOSDAQ companies.

Furthermore, the technology market-associated analysis apparatus 150 fetches patent information, trade information, chemistry information, and manufacturing company information over a communication network in order to construct a database for a product demand/supply connection network in accordance with an embodiment of the present invention, matches the pieces of information with each other based on HS codes, stores the pieces of matched information in a database storage space in the form of the hierarchical structure of a forward-oriented or backward-oriented demand/supply connection network, and constructs the database for the product demand/supply connection network into which the use of products and the combinational and hierarchical characteristics of components have been incorporated.

Furthermore, the product use providing apparatus 160 is an apparatus for providing products manufactured by manufacturing companies or the use of products distributed by distribution companies. The product use providing apparatus 160 may fetch the use of each product from a server or institution in technical association with the server or institution that provides the use of the product and may provide the use of each product to the technology market-associated analysis apparatus 150.

Furthermore, the communication network may include all of a wired communication network including the Internet, a mobile communication network, such as WCDMA or LTE, and a short-distance communication network, such as Zigbee or Wi-Fi.

### Mode for Invention

FIG. 2 is a block diagram schematically illustrating the functions of the technology market-associated analysis apparatus in accordance with an embodiment of the present invention.

Referring to FIG. 2, the technology market-associated analysis apparatus 150 in accordance with an embodiment of the present invention includes a communication unit 210, an information collection unit 220, a data classification unit 230, a connection network configuration generation unit 240, a database storage space 250, a service providing unit 260, and so on.

The communication unit 210 is a hardware element responsible for a communication function for communication with the patent information providing apparatus 110, the trade information providing apparatus 120, the chemistry information providing apparatus 130, and the company information providing apparatus 140 over the communication network.

The information collection unit 220 collects pieces of related information required for a product demand/supply connection network from the patent information providing apparatus 11, the trade information providing apparatus 120, the chemistry information providing apparatus 130, and the company information providing apparatus 140 over the communication network.

That is, the information collection unit 220 collects pieces of trade information including tariff-harmonized commodity description codes (i.e., harmonized system codes) from the trade information providing apparatus 120 over the communication network. Furthermore, the information collection unit 220 may collect CAS numbers from the chemistry information providing apparatus 130 and collect pieces of manufacturing company information from the company information providing apparatus 140.

Next, the data classification unit 230 fetches items based on tariff-harmonized commodity description codes from the pieces of trade information and classifies the fetched items into data sets based on HS codes. In this case, the data classification unit 230 may classify the fetched items into data sets according to regions, uses, and designated items.

Next, the connection network configuration generation unit 240 generates the items classified into the data sets in the form of the hierarchical structure of a forward-oriented or backward-oriented demand/supply connection network. In this case, the connection network configuration generation unit 240 may generate the items classified into the data sets in the form of a hierarchical structure in which a forward-oriented or backward-oriented demand/supply connection network can be selected.

In this case, the hierarchical structure of the forward-oriented demand/supply connection network is a structure in which the items of a product are connected from raw materials to the completed body through a process of the intermediate body of the product (the partial body of the product) and may be said to be a structure that reveals that what completed body has been formed by the raw materials of a product.

Furthermore, the hierarchical structure of the backward-oriented demand/supply connection network is a concept opposite to that of the forward-oriented meaning and may be said to be a structure that reveals that the completed body of the items of a product has been formed through which process.

The database storage space 250 stores the patent information fetched from the patent information providing apparatus 110, the HS codes fetched from the trade information providing apparatus 120, the CAS numbers fetched from the chemistry information providing apparatus 130, and the manufacturing company information fetched from the company information providing apparatus 140 over the communication network and also stores information about the hierarchical structure of the forward-oriented or backward-oriented demand/supply connection network.

The service providing unit 260 is a hardware element for controlling a product demand/supply connection network service based on tariff-harmonized commodity description codes according to the present invention and may be implemented using a microprocessor, for example. The service providing unit 260 provides information about the amount of trade of export- and import-related products, provides information about CAS numbers, technical patent numbers, and product regulations, or provides trade target countries and region-based items based on the hierarchical structure of the forward-oriented or backward-oriented demand/supply connection network.

Furthermore, the service providing unit 260 may provide the information about the amount of the trade of export- and import-related products, may provide the information about the CAS numbers, technical patent numbers, and product regulations, or may provide the trade target countries and the region-based items according to a combination of queries or a combination of words.

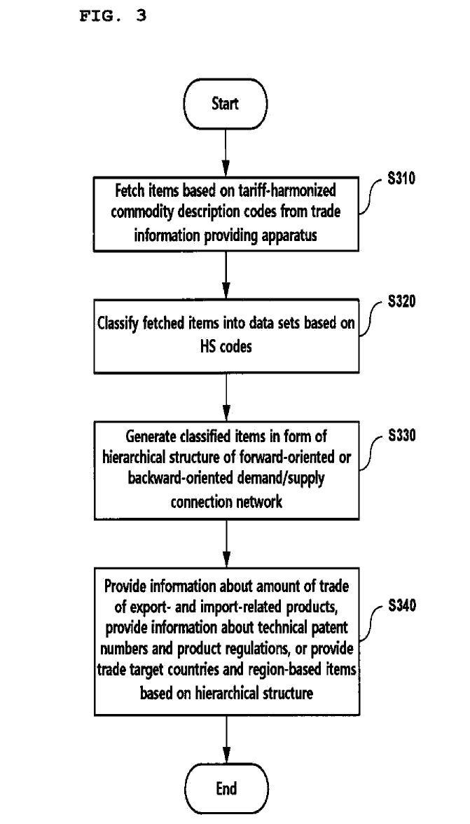

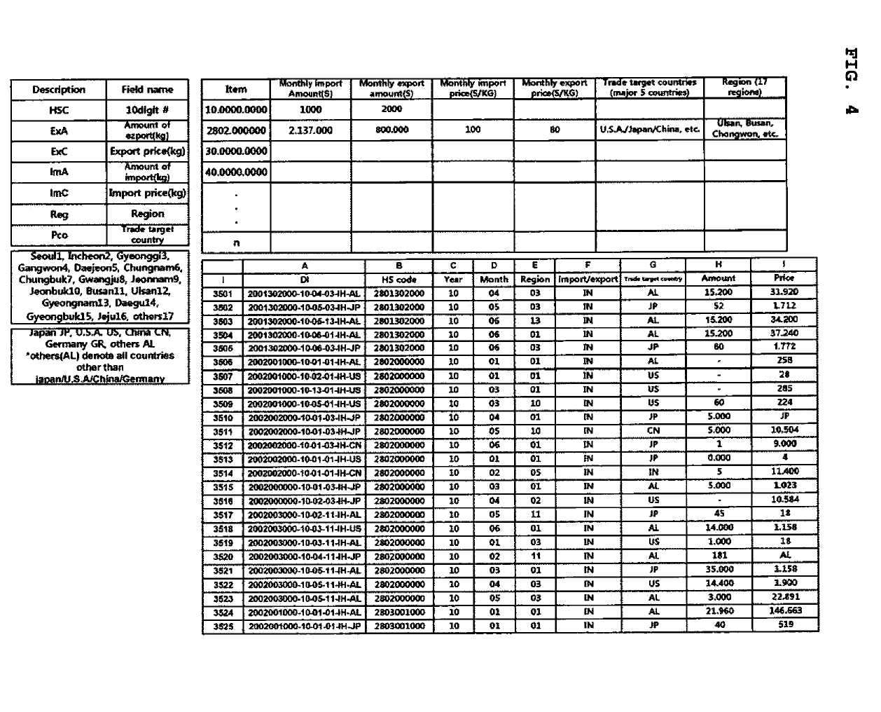

FIG. 3 illustrates a flowchart for illustrating a product demand/supply connection network service method based on tariff-harmonized commodity description codes in the technology market-associated analysis apparatus in accordance with an embodiment of the present invention.

Referring to FIG. 3, the service providing unit 260, that is, a microprocessor, of the technology market-associated analysis apparatus 150 in accordance with an embodiment of the present invention fetches items based on tariff-harmonized commodity description codes from the trade information providing apparatus 120 over the communication network (S310).

That is, the service providing unit 260 of the technology market-associated analysis apparatus 150 fetches trade information, including HS codes as illustrated in FIG. 4, from the trade information providing apparatus 120 for the product demand/supply connection network service. FIG. 4 is a diagram illustrating an example in which pieces of trade-related information are classified into a plurality of data sets based on HS codes in accordance with an embodiment of the present invention. In this case, as illustrated in FIG. 4, the trade information includes the HS code, the amount of export, an export price, the amount of import, an import price, a region, trade target countries, and regional names of a product.

In this case, the technology market-associated analysis apparatus 150 may fetch patent information, including an application No., an applicant, an application date, IPC classification, an inventor, an address, a country, the title of the invention, and an abstract, from the patent information providing apparatus 110, may fetch chemistry information, including a CAS number, big use classification, middle use classification, and small use classification, from the chemistry information providing apparatus 130, and may fetch pieces of information about each company from the company information providing apparatus 140 for the product demand/supply connection network service in accordance with an embodiment of the present invention.

Next, the service providing unit 240 classifies the fetched items into data sets based on Harmonized System (HS) codes as illustrated in FIG. 4 (S320).

That is, as illustrated in FIG. 4, the service providing unit 240 classifies the items, fetched from the trade information providing apparatus 120, into a plurality of data sets, such as a data set “dataset A” regarding all items, a data set “dataset B” regarding designated items, a data set “dataset C” regarding target regions, and a data set “dataset D” regarding the designation of uses, based on the HS codes of the trade information.

Next, the service providing unit 240 generates the items, classified into the data sets, in the form of the hierarchical structure of a forward-oriented or backward-oriented demand/supply connection network (S330).

In this case, the service providing unit 240 generates the classified items in the form of a hierarchical structure in which an administrator or a user may select the forward-oriented demand/supply connection network or the backward-oriented demand/supply connection network.

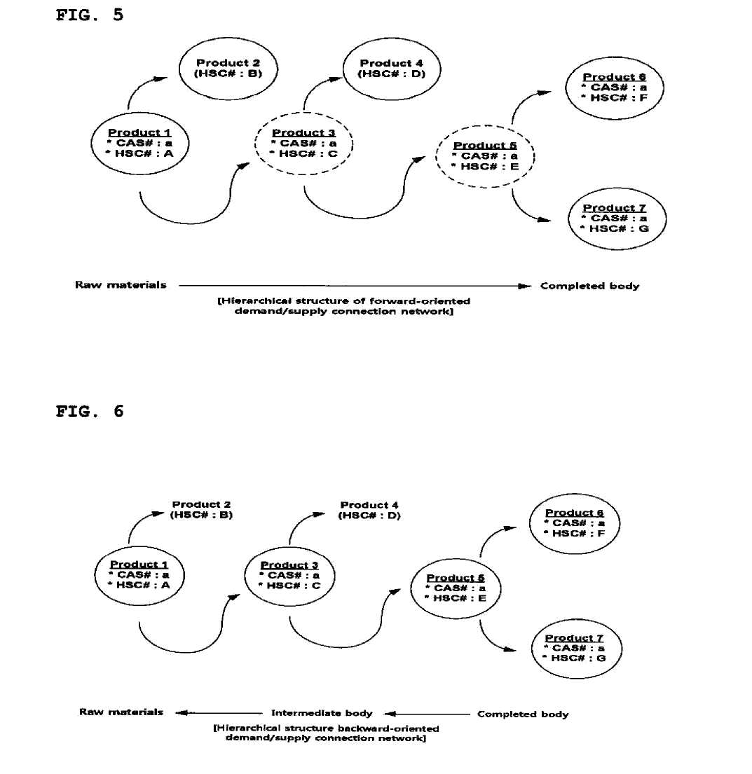

In this case, as illustrated in FIG. 5, in the hierarchical structure of the forward-oriented demand/supply connection network, the items of a product is connected from raw materials to the completed body via a process of the intermediate body of the produce (i.e., the partial body), thus revealing that what completed body has been finally formed by the raw materials of the product. FIG. 5 is a diagram illustrating the hierarchical structure of the forward-oriented demand/supply connection network in accordance with an embodiment of the present invention. As illustrated in FIG. 5, in the hierarchical structure of the forward-oriented demand/supply connection network, it may be understood that, for example, Product 2 having an HS code number HSC# of ‘B’ has been completed from a raw material product Product 1 having an HS code number HSC# of ‘A’, Product 4 having an HS code number HSC# of ‘D’ has been completed from the Product 1 having the HS code number HSC# of ‘A’ corresponding to raw materials, and Product 6 having an HS code number HSC# of ‘F’ has been completed from the Product 1 having the HS code number HSC# of ‘A’. Likewise, it may be understood that Product 7 having an HS code number HSC# of ‘G’ has also been completed from the Product 1 having the HS code number HSC# of ‘A’ corresponding to raw materials.

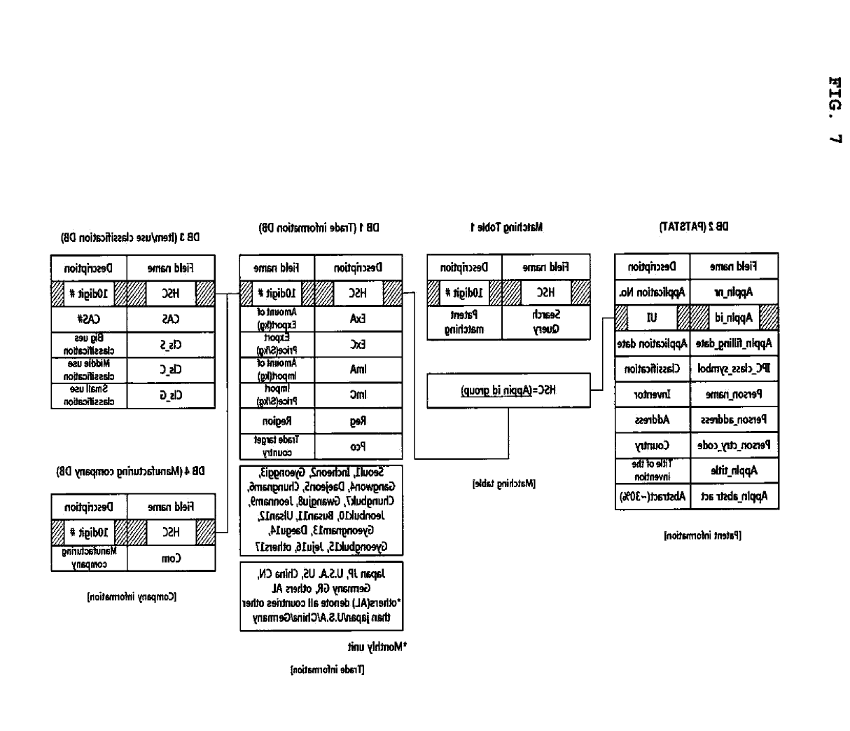

Meanwhile, as illustrated in FIG. 6, the hierarchical structure of the backward-oriented demand/supply connection network illustrates a structure that reveals that the completed body has been formed through which process in a direction opposite to the connection direction of the forward-oriented hierarchical structure. FIG. 6 is a diagram illustrating the hierarchical structure of the backward-oriented demand/supply connection network in accordance with an embodiment of the present invention. As illustrated in FIG. 6, in the hierarchical structure of the backward-oriented demand/supply connection network, it may be understood that, for example, Product 6 having an HS code number HSC# of ‘F’ has been completed from Product 1 that corresponds to raw materials and that has an HS code number HSC# of ‘A’ via Product 5 HSC#:E and Product 3 HSC#:C corresponding to intermediate bodies. Likewise, it may also be understood that Product 7 having an HS code number HSC# of ‘G’ has been completed from the Product 1 that corresponds to raw materials and that has the HS code number HSC# of ‘A’ via the Product 5 HSC#:E and the Product 3 HSC#:C corresponding to intermediate bodies.

Furthermore, the service providing unit 260 provides information about the amount of trade of export- and import-related products, provides information about CAS numbers, technical patent numbers, and product regulations, or provides trade target countries and region-based items based on the hierarchical structure of the forward-oriented or backward-oriented demand/supply connection network (S340).

In this case, the service providing unit 260 may receive queries or words from an administrator or user, and may provide information about the amount of trade of export- and import-related products, provide information about CAS numbers, technical patent numbers, and product regulations, or provide trade target countries and region-based items according to a combination of queries or a combination of words. To this end, as illustrated in FIG. 7, the technology market-associated analysis apparatus 150 uses a database in which trade information, chemistry information, patent information, and company information are matched with HS codes and constructed. FIG. 7 is a diagram illustrating an example of the database in which pieces of information used for the product demand/supply connection network service are matched with HS codes in accordance with an embodiment of the present invention. In FIG. 7, the patent information includes an application No., an applicant, an application date, IPC classification, an inventor, an address, a country, the title of the invention, an abstract, and so on. The trade information includes the amount of export, an export price, the amount of import, an import price, a region, trade target countries, and so on. The chemistry information includes a CAS number, big use classification, middle use classification, small use classification, and so on. That is, the patent information, the trade information, the chemistry information, and the company information stored in the database have been matched based on Harmonized System (HS) codes.

Accordingly, the service providing unit 260 may provide the information about the amount of trade of the export- and import-related products, may provide the information about the CAS numbers, technical patent numbers, and product regulations, and may provide the trade target countries and the region-based items using the database based on the hierarchical structure of the forward-oriented or backward-oriented demand/supply connection network.

As described above, in accordance with the present invention, the product demand/supply connection network service method and system based on tariff-harmonized commodity description codes can be realized in which trade products are sorted based on HS codes, that is, item classification codes obtained by generally sorting foreign trade transaction products in accordance with the Harmonized Commodity Description and Coding System, relationships between the trade products are connected to the raw materials, intermediate body, and completed body of a product, and the trade products are provided in the form of the hierarchical structure of a forward-oriented demand/supply connection network so that it is revealed that what completed body has been formed by the raw materials of the product or in the form of the hierarchical structure of a backward-oriented demand/supply connection network so that it is revealed that the completed body has been formed through which process.

Those skilled in the art to which the present invention pertains will understand that the present invention may be implemented in various detailed forms without changing the technical spirit or indispensable characteristics of the present invention. It will be understood that the aforementioned embodiments are illustrative and not limitative from all aspects. The scope of the present invention is defined by the appended claims rather than the detailed description, and the present invention should be construed as covering all modifications or variations derived from the meaning and scope of the appended claims and their equivalents.

### INDUSTRIAL APPLICABILITY

The present invention may be applied to a product demand/supply connection network service method and system based on tariff-harmonized commodity description codes, wherein trade products are sorted based on HS codes, that is, item classification codes obtained by generally sorting foreign trade transaction products in accordance with the Harmonized Commodity Description and Coding System, relationships between the trade products are connected to the raw materials, intermediate body, and completed body of a product, and the trade products are provided in the form of the hierarchical structure of a forward-oriented demand/supply connection network so that it is revealed that what completed body has been formed by the raw materials of the product or in the form of the hierarchical structure of a backward-oriented demand/supply connection network so that it is revealed that the completed body has been formed through which process.

1. A product demand/supply connection network service method based on tariff-harmonized commodity description codes in a technology market-associated analysis apparatus comprising a microprocessor that controls a product demand/supply connection network service, the method comprising steps of:
(a) fetching, by the microprocessor, items based on the tariff-harmonized commodity description codes from a trade information providing apparatus over a communication network;
(b) classifying, by the microprocessor, the fetched items into data sets based on Harmonized System (HS) codes;
(c) generating, by the microprocessor, the items classified into the data sets in a form of a hierarchical structure of a forward-oriented or backward-oriented demand/supply connection network; and
(d) providing, by the microprocessor, information about an amount of trade of export- and import-related products, information about Chemistry Abstract Service (CAS) registry numbers, technical patent numbers, and product regulations, or trade target countries and region-based items based on the hierarchical structure of the forward-oriented or backward-oriented demand/supply connection network.

2. The product demand/supply connection network service method of claim 1, wherein the step (b) comprises classifying, by the microprocessor, the items into the data sets according to regions, uses, and designated items.

3. The product demand/supply connection network service method of claim 1, wherein the step (c) comprises generating, by the microprocessor, the items in the form of the hierarchical structure in which the forward-oriented demand/supply connection network or the backward-oriented demand/supply connection network is able to be selected.

4. The product demand/supply connection network service method of claim 1, wherein:
the hierarchical structure of the forward-oriented demand/supply connection network is a structure in which the items of the product are connected to raw materials, intermediate/partial bodies of the product, and the completed body, thus revealing that what completed body has been formed by the raw materials of the product, and
the hierarchical structure of the backward-oriented demand/supply connection network is a structure that reveals that the completed body has been formed through which process.

5. The product demand/supply connection network service method of claim 1, wherein the step (d) comprises providing, by the microprocessor, the information about the amount of trade of the export- and import-related products, the information about the Chemistry Abstract Service (CAS) registry numbers, technical patent numbers, and product regulations, or the trade target countries and the region-based items according to a combination of queries or a combination of words.

6. A product demand/supply connection network service system based on tariff-harmonized commodity description codes, the system comprising:
an information collection unit collecting trade information, comprising the tariff-harmonized commodity description codes (Harmonized System (HS) codes), from a trade information providing apparatus over a communication network;
a data classification unit fetching items based on the tariff-harmonized commodity description codes from the trade information and classifying the fetched items into data sets based on the HS codes;
a connection network configuration generation unit generating the items, classified into the data sets, in a form of a hierarchical structure of a forward-oriented or backward-oriented demand/supply connection network; and
a service providing unit providing information about an amount of trade of export- and import-related products, providing Chemistry Abstract Service (CAS: Chemical Abstract Service Registry) registry numbers, technical patent numbers, and product regulations, or providing trade target countries and region-based items based on the hierarchical structure of the forward-oriented or backward-oriented demand/supply connection network.

7. The product demand/supply connection network service system of claim 6, wherein the information collection unit collects patent information from a patent information providing apparatus, the CAS numbers from a chemistry information providing apparatus, and manufacturing company information from a manufacturing company information providing apparatus with respect to information required for the product demand/supply connection network.

8. The product demand/supply connection network service system of claim 6, wherein the data classification unit classifies the items into the data sets according to regions, uses, and designated items.

9. The product demand/supply connection network service system of claim 6, wherein the connection network configuration generation unit generates the items in the form of the hierarchical structure in which the forward-oriented demand/supply connection network or the backward-oriented demand/supply connection network is able to be selected.

10. The product demand/supply connection network service system of claim 6, wherein:
the hierarchical structure of the forward-oriented demand/supply connection network is a structure in which the items of the product are connected to raw materials, intermediate/partial bodies of the product, and the completed body, thus revealing that what completed body has been formed by the raw materials of the product, and
the hierarchical structure of the backward-oriented demand/supply connection network is a structure that reveals that the completed body has been formed through which process.

11. The product demand/supply connection network service system of claim 6, wherein the service providing unit provides the information about the amount of trade of the export- and import-related products, the information about the Chemistry Abstract Service (CAS) registry numbers, technical patent numbers, and product regulations, or the trade target countries and the region-based items according to a combination of queries or a combination of words.
